(19) United States
(12) Patent Application Publication
(10) Pub. No.: US 2014/0044055 A1
(43) Pub. Date: Feb. 13, 2014

(54) Method and Apparatus for Resource Relocation in a Wireless Communication Network

(71) Applicant: Telefonaktiebolaget LM Ericsson (publ), (US)

(72) Inventors: Alessandro Caverni, Stockholm (SE); Jose Luis Pradas, Stockholm (SE)

(73) Assignee: TELEFONAKTIEBOLAGET LM ERICSSON (PUBL), Stockholm (SE)

(21) Appl. No.: 13/743,862

(22) Filed: Jan. 17, 2013

Related U.S. Application Data
(60) Provisional application No. 61/590,585, filed on Jan. 25, 2012.

(51) Int. Cl. H04W 28/16

(52) U.S. Cl. CPC H04W 28/16
USPC 370/329

(57) ABSTRACT

In an example configuration, a user equipment (UE) is configured such that, when transmitting a first type of data on first common Enhanced Dedicated Channel (E-DCH) resources, the UE calculates a Total E-DCH Buffer Status (TEBS) based on available data of the first type and excludes from the calculation any available data of a second type. Correspondingly, the UE is configured to trigger release of the first common E-DCH resources responsive to determining that the TEBS equals zero, as calculated for the first type of data. In this context, the first type of data comprises one of Common Control Channel (CCCH) data and Dedicated Traffic Channel/Dedicated Control Channel (DTCH/DCCH) data, and the second type of data comprises the other one of CCCH data or DTCH/DCCH data.

### RELATED APPLICATIONS

This application claims priority from the U.S. provisional patent application filed on 25 Jan. 2012 and assigned App. No. 61/590,585, which application is herein incorporated by reference.

### TECHNICAL FIELD

The present invention generally relates to wireless communication networks, and particularly relates to the use of radio resources in a wireless communication network.

### BACKGROUND

With respect to at least some of the subject matter herein, the following documents serve as helpful references: 3GPP TS 25.321 v8.14.0, “Medium Access Control (MAC) protocol specification” and 3GPP TS 25.331 v8.17.0, “Radio Resource Control (RRC); Protocol specification.” For example, these documents and in particular the latter one of these documents explain certain aspects of “connected” and “idle” modes in the context of RRC, including providing details regarding the various states of connected mode operation. The various connected mode states include CELL_DCH (Dedicated Channel), CELL_FACH (Forward access channel), CELL_PCH (Cell Paging channel) and URA_PCH (URA Paging channel).

Information regarding Enhanced Dedicated Transport Channel (E-DCH) details is also of interest. Broadly, the E-DCH is an uplink channel that can be used by user equipments or “UEs” on both scheduled and unscheduled bases. For Frequency Division Duplex (FDD), E-DCH transmission by a UE in the CELL_FACH state and in the Idle Mode is a mechanism to improve the performance of the random access procedure. The Enhanced Uplink in CELL_FACH state and Idle mode combines the Release 99 random access power ramping phase with E-DCH transmission on common E-DCH resources.

The network can configure up to thirty-two (32) common E-DCH resources in one cell. The configuration information is broadcast by System Information (SI) 5/5bis. The E-DCH random access procedure consists of the following steps: access request preamble transmissions with preamble power ramping as in Rel99; acquisition indication and assignment of a common E-DCH resource; data transmission over the assigned E-DCH channel (the assigned resource), which is used to carry either a Common Control Channel (CCCH) transmission or Dedicated Traffic Channel/Dedicated Control Channel (DTCH/DCCH) transmission; and subsequent release of the common E-DCH resource.

For DTCH/DCCH transmissions, common E-DCH resources conventionally can be released in the following ways: (1) explicitly by the Node B, by sending a release command on the E-DCH Absolute Grant Channel (E-AGCH) after or at the end of collision resolution; (2) if configured by the network, implicitly by the UE—where the UE releases E-DCH resources after an empty buffer status has been reported in the Scheduling Information (SI) sent to the Node B, and after the last Hybrid Automatic Repeat reQuest (HARQ) process has been acknowledged or after a maximum number of retransmission has been reached; (3) if contention resolution fails, i.e., no absolute grant is received by the UE; (4) during state transition from CELL_FACH to CELL_DCH (Dedicated Channel); or (5) upon a radio link failure.

For CCCH transmissions, common E-DCH resources conventionally can be released in the following ways: (1) the UE releases the resources after an empty buffer status has been reported in the SI to the Node B, and after the last HARQ process has been acknowledged or after a maximum number of retransmission has been reached; (2) after a period of time configured by the network; and (3) upon a radio link failure.

Section 11.2.2A “Control of Enhanced Uplink in CELL_FACH state and Idle mode for FDD mode” of 3GPP TS 25.321 describes how the allocated common E-DCH resources are released. In the context of a CCCH transmission, the E-DCH enhanced physical random access transmission procedure is completed with release of the allocated common E-DCH resource, if one of the following conditions is fulfilled: (a) in case of CCCH transmission, if the maximum E-DCH resource allocation for CCCH has been reached, then this triggers a CMAC-STATUS-Ind which informs the RRC about the Enhanced Uplink in CELL_FACH state and Idle mode process termination; or (b) in case of CCCH transmission, if the Total E-DCH Buffer Status (TEBS) is 0 bytes, then the MAC-STATUS-Ind primitive indicates to the Radio Link Control (RLC) layer for each logical channel that no Protocol Data Unit (PDU) shall be transferred to MAC. If the TEBS equals 0 bytes and no MAC-i PDUs are left for (re-) transmission in MAC, this triggers a CMAC-STATUS-Ind which informs the RRC about the Enhanced Uplink in CELL_FACH state and Idle mode process termination.

The “Maximum E-DCH resource allocation for CCCH” is received by higher layers, and is broadcasted by the network in the “Common E-DCH system info” in SIB5 or SIB5bis—see 3GPP TS25.331, where “SIB” denotes System Information Block. The value of “Maximum E-DCH resource allocation for CCCH” can be set to any of these values (expressed in Transmission Time Intervals (TTIs)): 8, 12, 16, 20, 24, 32, 40, and 80.

For further reference, MAC-i/is, MAC-c MAC-d are different entities of the MAC layer, defined as follows:—MAC-d is the MAC entity that handles the dedicated logical channels DCCH and DTCH and maps them onto the E-DCH;—MAC-c/sh/m, is the MAC entity that handles the paging channel (PCH), the forward access channel (FACH), random access channel (RACH), the downlink shared channel (DSCH), which exists only in TDD mode, and the uplink shared channel (USCH), which exists only in TDD mode; and—MAC-e/es and MAC-i/is are the MAC entities that handle the enhanced dedicated transport channel (E-DCH).

Regarding MAC-i/is segmentation, the MAC-i/is entity has the possibility of transmitting only one part (segment) of a MAC-c or MAC-d PDU, if the entire PDU does not fit into a MAC-is SDU. More details regarding how a MAC-i PDU is built can be found in TS25.321 section 9.1.5.

Further, 3GPP TS 25.321 defines for FDD the TEBS as follows: the TEBS field identifies the total amount of data available across all logical channels for which reporting has been requested by the RRC and indicates the amount of data in number of bytes that is available for transmission and retransmission in the RLC layer. If MAC-i/is configured, TEBS also includes the amount of data that is available for transmission in the MAC-i/is segmentation entity. When MAC is connected to an “Acknowledged Mode” (AM) RLC entity, control PDUs to be transmitted and RLC PDUs outside the RLC Tx (transmit) window shall also be included in the TEBS. RLC PDUs that have been transmitted but not negatively acknowledged by the receiving peer entity shall not be included in the TEBS.

Section 11.8.1.6 “Scheduling Information reporting” of 3GPP TS 25.321 v8.14.0, specifies how the Scheduling Information (SI) shall be triggered at a UE in case of CCCH transmission in Cell FACH state: for FDD and for CCCH transmission in CELL_FACH state and Idle mode, the transmission of SI shall only be triggered when TEBS becomes zero and the MAC-i PDU containing the last data is being transmitted. The SI is transmitted with the MAC-i PDU carrying the last data, if the current serving grant is sufficient to carry the SI with the last remaining data. Otherwise, the empty buffer status report is transmitted separately with the next MAC-i PDU.

However, there are instances where TEBS will not be zero, even upon transmission of the last data that can be transmitted on the common E-DCH resource allocated for a given transmission. In particular, the current standard specifies that the allocated common E-DCH resource shall be used by MAC either to carry only a CCCH transmission or only a DTCH/DCCH transmission, but not both. Thus, a UE may have CCCH data and DTCH/DCCH data available for transmission on common E-DCH resources, but only one or the other type of data may be transmitted on a given allocation of common E-DCH resources. For example, the UE may transmit all CCCH data available for a given allocation of common E-DCH resources, but have DTCH/DCCH data buffered that is not permitted to be sent using the given current allocation of common E-DCH resources.

After completing the transmission on CCCH, there are several mechanisms for the UE to release the common E-DCH resources (as were outlined in the previous section). Particularly, the resources will be released after a period equal to “Maximum E-DCH resource allocation for CCCH,” as calculated from the allowed start time of the E-DCH transmission. This period can be up to 80 TTI, i.e., 800 msec in case of 10 msec TTIs. Or, if the TEBS at the UE becomes zero after transmitting the last MAC-i PDU, the UE triggers an SI reporting the TEBS equals zero condition and then releases the common E-DCH resources that were used for the CCCH transmission. Here, the release may occur after the last HARQ process has been acknowledged or the maximum number of retransmission has been reached.

One issue recognized herein relating to the TEBS-based release is that the TEBS includes the total amount of data available across all the logical channels and the amount of data available for transmission in the MAC-i/is segmentation entity. The completion of CCCH transmission therefore does not guarantee the release of the common E-DCH resources, because the TEBS value may not be zero (0), in case where there is data for one or more of the logical channels other than the CCCH. This circumstance may arise, for example, when performing a CELL_UPDATE, which is sent over CCCH. In particular, if user data arrives prior to sending the CELL UPDATE, the TEBS may not be zero.

On the other hand, data corresponding to other logical channels (i.e. DCCH and DTCH) cannot be transmitted using the same common E-DCH resources used for CCCH transmission. The UE will first have to release the common E-DCH resources. The release will happen when the timeout condition is fulfilled, i.e. at the expiry of the “Maximum E-DCH resource allocation for CCCH.”

Following the current specification, in the case outlined above, TEBS will not be zero and, therefore, the UE will not send the SI with TEBS equal to zero. Hence, the common E-DCH resources will not be released after a given CCCH transmission, even if the UE cannot transmit any other data using those resources. Consequently, the common E-DCH resources will only be freed when the UE reaches the “Maximum E-DCH resource allocation for CCCH.”

This delay in the release represents a waste of resources, both for the network and the UE. It also delays the subsequent transmission of DTCH/DCCH, because such transmission may happen only after the common E-DCH resources used for CCCH transmission are released.

Turning to the DTCH/DCCH transmission case, one of the mechanisms used to release common E-DCH resources is the implicit release with E-DCH transmission continuation backoff. Implicit resource release is enabled only if “E-DCH transmission continuation back off” is not set to “infinity.” If implicit resource release is enabled, then in case of a DTCH/DCCH transmission on common E-DCH resources, the timer Tb is set to “E-DCH transmission continuation back off” value, when the TEBS equals zero (0 bytes) and the last generated MAC-i PDU with higher layer data is provided with the PHY-data-REQ primitive to the physical layer for transmission.

If the TEBS not-equal-to-zero is detected while timer Tb is running, then the timer is stopped and uplink data transmission on the common E-DCH resource continues. If a MAC-ehs PDU is received while timer Tb is running, then the timer is re-started. If the “E-DCH transmission continuation back off” value is set to “0” or if timer Tb expires, the MAC-STATUS-Ind primitive indicates to RLC for each logical channel that no PDUs shall be transferred to MAC. TEBS equals zero is reported to the Node B MAC as SI in a MAC-i PDU. If the “E-DCH transmission continuation back off” value is set to ‘0”, then the SI shall be transmitted with the MAC-i PDU carrying the last DTCH/DCCH data, if the current serving grant is sufficient to carry the SI in the same MAC-i PDU together with the remaining DTCH/DCCH data. Otherwise, the empty buffer status report is transmitted separately with the next MAC-i PDU.

CMAC-STATUS-Ind which informs the RRC about the Enhanced Uplink in CELL_FACH state and Idle mode process termination is triggered when the TEBS equals zero condition has been reported and no MAC-i PDU is left in any HARQ process for (re-) transmission.

Thus, it is recognized herein that DTCH/DCCH transmissions on the common E-DCH suffer from a resource release problem that is similar to the one described for the CCCH case, i.e., the TEBS as calculated by the UE includes the total amount of data available across all the logical channels, including any available CCCH data, and the amount of data available for transmission in the MAC-i/is segmentation entity. The completion of DTCH/DCCH transmission therefore does not always trigger the start of the timer Tb or the immediate release of the resources (if Tb=0) because the TEBS will not be zero if there is available data for logical channels other than DTCH/DCCH. For example, for a given DTCH/DCCH transmission on a given allocation of common E-DCH resources, TEBS at the UE will not be zero if a periodic CELL_UPDATE, which has to be sent over CCCH, is triggered just before the UE completes its DTCH/DCCH transmission.

### SUMMARY

An example method taught herein involves a user equipment (UE) that is configured to, when transmitting a first type of data on first common Enhanced Dedicated Channel (E-DCH) resources, calculate a Total E-DCH Buffer Status (TEBS) based on available data of the first type and exclude from the calculation any available data of a second type. Correspondingly the UE is further configured to trigger release of the first common E-DCH resources responsive to determining that the TEBS equals zero, as calculated for the first type of data. In this context, the first type of data comprises one of Common Control Channel (CCCH) data and Dedicated Traffic Channel/Dedicated Control Channel (DTCH/DCCH) data, and the second type of data comprises the other one of CCCH data or DTCH/DCCH data.

In an example case, the first type of data is CCCH data and the second type of data is DTCH/DCCH data, and the calculation of the TEBS for CCCH data transmission on common E-DCH resources excludes consideration of DTCH/DCCH data. Alternatively, the first type of data is DTCH/DCCH data and the second type of data is CCCH data, and the calculation of the TEBS for DTCH/DCCH data transmission on common E-DCH resources excludes consideration of CCCH data. Of course, a UE as contemplated herein may be configured to perform both operations—i.e., to exclude DTCH/DCCH data when calculating the TEBS for a given transmission of CCCH data on common E-DCH resources, and to exclude CCCH data when calculating the TEBS for a given transmission of DTCH/DCCH data on common E-DCH resources.

Among the several advantages of the above operations is quicker release of the common E-DCH resources. For example, in the context of a CCCH transmission on given common E-DCH resources, the UE releases those resources upon transmission of the last available CCCH data, regardless of whether there is DTCH/DCCH data available for transmission on common E-DCH resources.

Such operation allows, for example, a quicker allocation of new common E-DCH resources to the UE, for transmission of the DTCH/DCCH data. The converse applies, too. That is, in another example, the UE releases given common E-DCH resources upon transmission of the last available DTCH/DCCH data, regardless of whether there is CCCH data available for transmission on common E-DCH resources. Such operation allows, for example, a quicker allocation of new common E-DCH resources to the UE, for the transmission of the CCCH data. More generally, application of the teachings herein result in quicker release of common E-DCH resources for any given subsequent usage within the overall, ongoing operations of the wireless communication network.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of one embodiment of a network that includes a user equipment (UE) configured according to example teachings herein.

FIG. 2 is a block diagram of one embodiment of the UE introduced in FIG. 1.

FIG. 3 is a logic flow diagram of one embodiment of a method at a UE of releasing common Enhanced Dedicated Channel (E-DCH) resources as taught herein.

### DETAILED DESCRIPTION

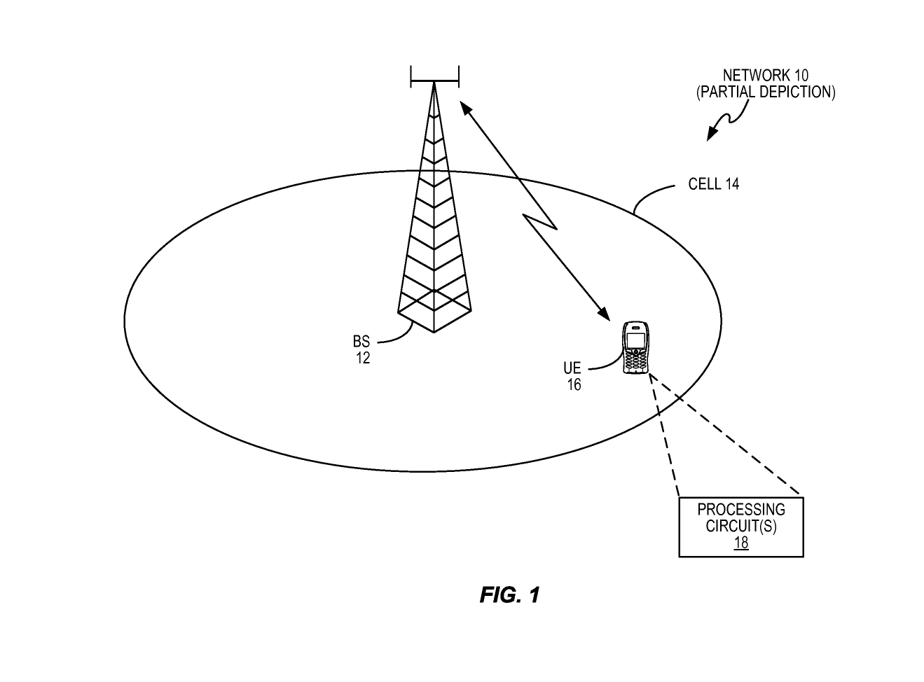

FIG. 1 illustrates a wireless communication network 10, which may be a UTRAN or E-UTRAN network. While the illustration is partial—i.e., the network 10 may include any number of additional Radio Access Network (RAN) nodes and Core Network (CN) nodes, the illustration provides a helpful context by depicting a base station (BS) 12 and its associated cell 14, in which one or more UEs 16 operate. The base station (BS) 12 may be, in non-limiting examples, a NodeB in a UTRAN network or an eNodeB (eNB) in an E-UTRAN network.

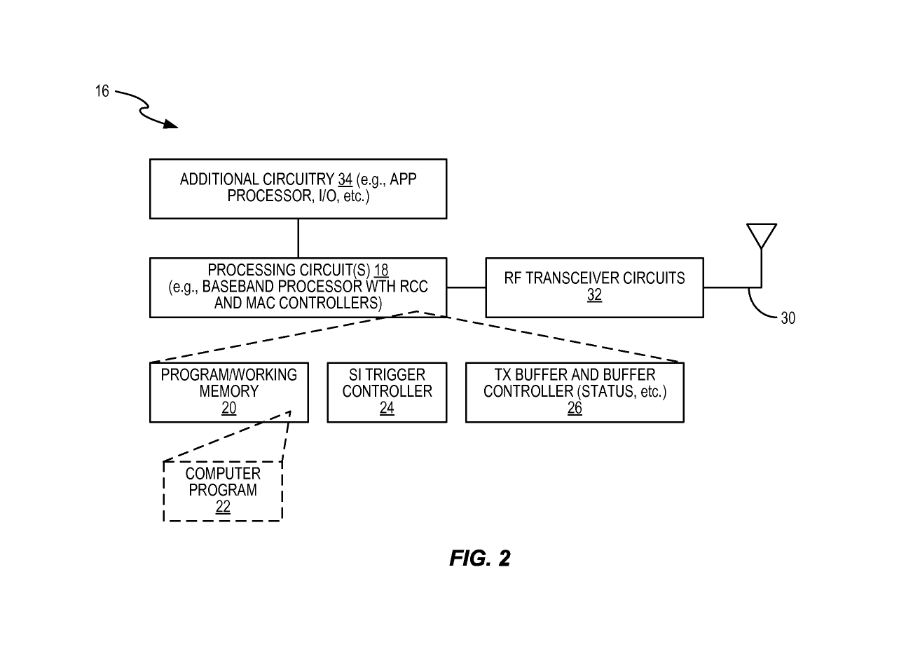

The UE 16 operates according the teachings presented herein based on the configuration of its one or more processing circuits 18. Such configuration is accomplished using fixed circuitry, programmed circuitry, or some combination thereof. In this regard, FIG. 2 provides example details for the physical and/or functional implementation of the UE 16, including the one or more processing circuits 18.

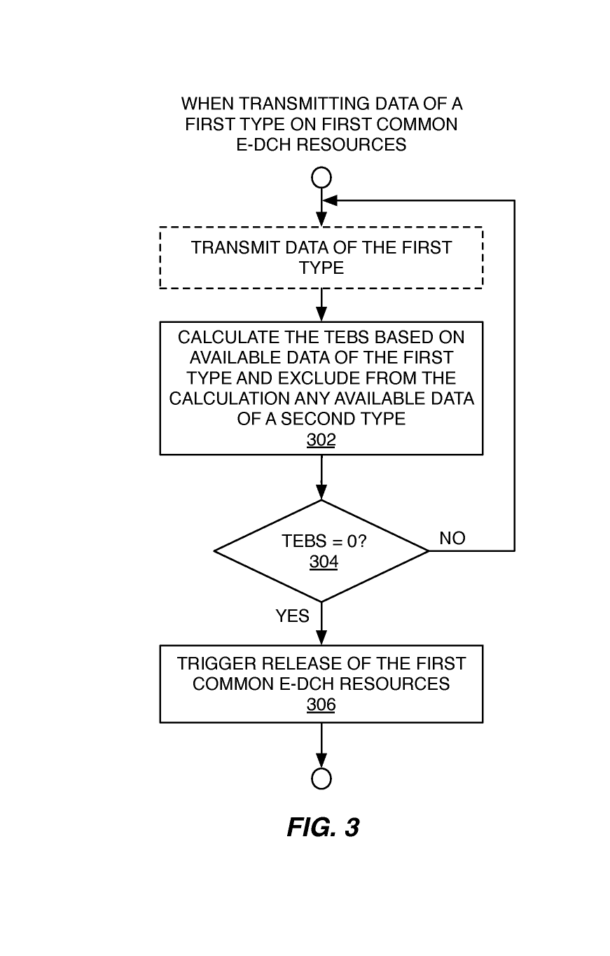

According to the example of FIG. 2, the one or more processing circuits 18 may comprise one or more microprocessor-based circuits that include or are associated with program and working memory 20 (which may comprise multiple memory elements, including non-volatile memory for storage of a computer program 22). For example, the computer program 22 includes computer program instructions that, when executed by the processing circuit(s) 18, configure such circuitry to carry out the method 300 shown in FIG. 3, or variations or extensions thereof.

Thus, the processing circuit(s) 18 can be understood as including any number of physical or functional processing units or controllers that are configured to carry out the method 300. For example, the processing circuit(s) 18 may be configured to implement a trigger controller 24 and a TX buffer controller 26 that implement the method 300, possibly with the cooperation of other processing units implemented via the processing circuit(s) 18, including those involved in the Radio Link Control/Medium Access Control/Physical (RLC/MAC/PHY) signaling and protocol control between the UE 16 and the network 10. That is, the processing circuits 18 implement the UE-side MAC, RLC, and other protocol layer entities discussed herein.

In general, the UE 16 includes one or more antennas 30 for receiving/transmitting signals, and transceiver circuits 32 operatively connected to the antenna(s) 30. The UE 16 also may include additional processing circuitry 34, e.g., one or more “application” processors for running high-level applications and/or input/output (I/O) circuitry. Of course, the extent and nature of such additional circuitry 34 will depend on the UE's features and intended use.

However implemented, the processing circuit(s) 18 is/are configured to implement the improved resource releasing method(s) described herein for common E-DCH resources used for CCCH transmission and/or for DTCH/DCCH transmission. For example, according to one example embodiment, the UE 16 is configured to implement a method wherein, when performing a CCCH transmission on first common E-DCH resources in a wireless communication network 10, the UE 16 calculates the TEBS based on the CCCH data available for transmission on the first common E-DCH resources and excludes from the calculation of the TEBS any consideration of DTCH/DCCH data. Correspondingly, the UE 16 is configured to trigger release of the first common E-DCH resources responsive to determining that the TEBS equals zero, as calculated for the CCCH data. Here, the “first common E-DCH resources” will be understood as a given current allocation of common E-DCH resources for use in performing the CCCH transmission.

The UE 16 may be further configured such that, when performing a DTCH/DCCH transmission on second common E-DCH resources in the wireless communication network 10, the UE 16 calculates the TEBS based on DTCH/DCCH data available for transmission on the second common E-DCH resources and excludes from that calculation any consideration of CCCH data. Correspondingly, the UE 16 is configured to trigger release of the second common E-DCH resources responsive to determining that the TEBS equals zero, as calculated for the DTCH/DCCH data. Here, the “second common E-DCH resources” will be understood as a given current allocation of common E-DCH resources for use in performing the DTCH/DCCH transmission. Thus, “first” and “second” in this context are merely clarifying labels for distinguishing between different allocations of common E-DCH resources, e.g., a given allocation for a CCCH transmission and a given allocation for a DTCH/DCCH transmission.

Broadly, with respect to the transmission of a first type of data on first common E-DCH resources, the one or more processing circuits 18 of the UE 16 are configured to: calculate the TEBS (for that transmission) based on available data of the first type and exclude from the calculation any available data of a second type; and trigger release of the first common E-DCH resources responsive to determining that the TEBS equals zero, as calculated for the first type of data. The first type of data comprises one of CCCH data and DTCH/DCCH data, and the second type of data comprises the other one of CCCH data or DTCH/DCCH data.

In a particular example, the first type of data is CCCH data and the second type of data is DTCH/DCCH data, and the one or more processing circuits 18 are configured to exclude consideration of DTCH/DCCH data when calculating the TEBS for CCCH data transmission. In another example, the first type of data is DTCH/DCCH data and the second type of data is CCCH data, and the one or more processing circuits 18 are configured to exclude consideration of CCCH data when calculating the TEBS for DTCH/DCCH data transmission.

Further, in at least some embodiments, the one or more processing circuits 18 are configured to trigger the release of the first common E-DCH resources based on sending SI in conjunction with transmitting the last available data of the first type from the UE 16, wherein the SI includes the TEBS=0 value, as calculated only in consideration of the first type of data. Still further, in at least some such embodiments, the one or more processing circuits 18 are configured to release the first common E-DCH resources after the transmission of the SI with TEBS=0 and after a last Hybrid Automatic Repeat reQuest (HARQ) process running at the UE 16 has been acknowledged or a predefined maximum number of retransmissions by the UE 16 has been reached.

In this regard, the one or more processing circuits 18 may at least functionally include an SI trigger controller 24 configured to trigger the SI transmission toward the network 10 according to the foregoing example. Further, a TX buffer and buffer controller 26 may be implemented in the processing circuit(s) 18. The TX buffer and buffer controller 26 in an example embodiment are configured to manage data buffering for transmissions on the E-DCH and/or to control how the TEBS is calculated at the UE 16 for different types of transmissions on common E-DCH resources, and to control SI reporting sent to the network 10.

Turning to FIG. 3 in more detail, the illustrated method 300 serves as an example processing flow at the UE 16. In particular, the method (300) applies when the UE 16 is transmitting a first type of data on first common E-DCH resources, and includes: calculating (Block 302) the TEBS based on available data of the first type and excluding from the calculation any available data of a second type; and triggering (Block 306) release of the first common E-DCH resources responsive to determining (Block 304) that the TEBS equals zero, as calculated for the first type of data. In the context of such processing, the first type of data comprises one of CCCH data and DTCH/DCCH data, and the second type of data comprises the other one of CCCH data or DTCH/DCCH data.

For example, for a DCCH/DTCH transmission in CELL_FACH, the UE 16 does not consider MAC-c PDU and RLC PDUs associated with the CCCH logical channel when calculating the TEBS value. Thus, in case of a DCCH/DTCH transmission on E-DCH in CELL_FACH, the TEBS is based on the total amount of data available across all logical channels, except CCCH, for which reporting has been requested by the RRC and indicates the amount of data in number of bytes that is available for transmission and retransmission in RLC layer (except the RLC data associated to CCCH). If MAC-i/is configured, TEBS also includes the amount of data that is available for transmission in the MAC-i/is segmentation entity, excluding MAC-c data. When MAC is connected to an Acknowledged Mode (AM) RLC entity, control PDUs to be transmitted and RLC PDUs outside the RLC Tx window shall also be included in the TEBS. RLC PDUs that have been transmitted but not negatively acknowledged by the receiving peer entity shall not be included in the TEBS.

Such operation, and corresponding operation for the converse case involving CCCH data transmission, allows the UE 16 to quickly release the current allocation of common resources on the E-DCH upon sending the last available data of the type for which the allocation was made—e.g., common E-DCH resources allocated for a CCCH transmission are released by the UE 16 upon sending the last available CCCH data, even if there is DTCH/DCCH data available for transmission at the UE 16. This arrangement avoids incurring the resource release timeout that would otherwise occur in such circumstances. Additionally or alternatively, common E-DCH resources allocated for a DTCH/DCCH transmission are released by the UE 16 upon sending the last available DTCH/DCCH data, even if there is CCCH data available for transmission at the UE 16.

Of course, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

What is claimed is:

1. A method in a user equipment (UE) comprising, when transmitting a first type of data on first common Enhanced Dedicated Channel (E-DCH) resources:
calculating a Total E-DCH Buffer Status (TEBS) based on available data of the first type and excluding from the calculation any available data of a second type; and
triggering release of the first common E-DCH resources responsive to determining that the TEBS equals zero, as calculated for the first type of data;
wherein the first type of data comprises one of Common Control Channel (CCCH) data and Dedicated Traffic Channel/Dedicated Control Channel (DTCH/DCCH) data, and wherein the second type of data comprises the other one of CCCH data or DTCH/DCCH data.

2. The method of claim 1, further wherein the first type of data is CCCH data and the second type of data is DTCH/DCCH data, and wherein calculation of the TEBS for CCCH data transmission excludes consideration of DTCH/DCCH data.

3. The method of claim 1, further wherein the first type of data is DTCH/DCCH data and the second type of data is CCCH data, and wherein calculation of the TEBS for DTCH/DCCH data transmission excludes consideration of CCCH data.

4. The method of claim 1, wherein triggering the release of the first common E-DCH resources comprises sending Scheduling Information (SI) in conjunction with transmitting the last available data of the first type from the UE, wherein the SI includes the TEBS as calculated only in consideration of the first type of data.

5. The method of claim 4, further comprising releasing the first common E-DCH resources after the transmission of the SI and after a last Hybrid Automatic Repeat reQuest (HARQ) process running at the UE has been acknowledged or a predefined maximum number of retransmissions by the UE has been reached.

6. A user equipment (UE) configured for operation in a wireless communication network and comprising:
transceiver circuits for transmitting signals to the wireless communication network (10) and receiving signals from the wireless communication network; and
one or more processing circuits that are operatively associated with the transceiver circuits and, for transmission of a first type of data on first common Enhanced Dedicated Channel (E-DCH) resources, said one or more processing circuits are configured to:
calculate a Total E-DCH Buffer Status (TEBS) based on available data of the first type and excluding from the calculation any available data of a second type; and
trigger release of the first common E-DCH resources responsive to determining that the TEBS equals zero, as calculated for the first type of data;
wherein the first type of data comprises one of Common Control Channel (CCCH) data and Dedicated Traffic Channel/Dedicated Control Channel (DTCH/DCCH) data, and wherein the second type of data comprises the other one of CCCH data or DTCH/DCCH data.

7. The UE of claim 6, further wherein the first type of data is CCCH data and the second type of data is DTCH/DCCH data, and wherein the one or more processing circuits are configured to exclude consideration of DTCH/DCCH data when calculating the TEBS for CCCH data transmission.

8. The UE of claim 6, further wherein the first type of data is DTCH/DCCH data and the second type of data is CCCH data, and wherein the one or more processing circuits are configured to exclude consideration of CCCH data when calculating the TEBS for DTCH/DCCH data transmission.

9. The UE of claim 6, wherein the one or more processing circuits are configured to trigger the release of the first common E-DCH resources based on sending Scheduling Information (SI) in conjunction with transmitting the last available data of the first type from the UE, wherein the SI includes the TEBS as calculated only in consideration of the first type of data.

10. The UE of claim 9, wherein the one or more processing circuits are configured to release the first common E-DCH resources after the transmission of the SI and after a last Hybrid Automatic Repeat reQuest (HARD) process running at the UE has been acknowledged or a predefined maximum number of retransmissions by the UE has been reached.
